(19) United States
(12) Patent Application Publication
(10) Pub. No.: US 2019/0129963 A1
(43) Pub. Date: May 2, 2019

(54) LAYER ENGINE FOR MEDIA TRANSITION EFFECTS

(71) Applicant: NCR Corporation, Duluth, GA (US)

(72) Inventors: Darren Ross Hromas, College Station, TX (US); Josiah David Blaisdell, College Station, TX (US); Lawrence Dustin Rowe, Bryan, TX (US); Joseph Laval Tremblay, College Station, TX (US); Brett Jamison Wolfe, College Station, TX (US)

(21) Appl. No.: 15/797,671

(22) Filed: Oct. 30, 2017

(51) Int. Cl. G06F 17/30; G06F 3/14; H04N 21/2343

(52) U.S. Cl. CPC G06F 17/30056; G06F 17/30061; H04N 21/234336; G06F 3/1423

(57) ABSTRACT

Disclosed are systems and methods for transitioning from a first content to a second content on a display. The systems and methods may include: receiving, at a computing device comprising a processor, the first content and the second content; determining, by the computing device, a transition sequence for transitioning from the first content to the second content; and displaying, by the computing device, the transition sequence on a first panel of the display. The display divided into a plurality of panels.

### SUMMARY

Media players may be used in public locations to display information. For example, media players may be located in public areas such as airports and may display flight information. In addition, media players may be located in restaurants and display menu items. The content on the media players may change periodically.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an operating environment for a layer engine for media transition effects consistent with this disclosure.

FIGS. 2A-2D show an example transition sequence consistent with this disclosure.

FIG. 3 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit this disclosure. Instead, the proper scope of any invention disclosed herein is defined by the appended claims.

A display can be divided into multiple panels. Each of the panels may display different content. Over time the content in one or more of the panels may transition from a first content to a second content. For example, at one instance of time, a static image may be displayed in a panel and at a later time a video may be displayed in the panel.

As the panel transitions from the first content to the second content a transition effect may be used. The transition effect may allow for a smooth transition that is pleasant to a viewer's eyes. For example, instead of a sudden change from a static image to a video or a video to a static image, a transition effect may be used to gradually change the content. The duration of the transition effect may depend on the content. For instance, if the content transitions from a static image to a video the duration of the transition may be different than if the content transitions from a first static image to a second static image. The duration of the transition effect may be configured by the layer engine as disclosed herein. For example, the layer engine may assign the duration of the transition effect at random or based on the content.

One example of the transition effects may include a cross dissolve where the first content fades into the second content. Another example of the transition effect may include a slide transition were the first content slides in a first direction and the second contents slides in the first direction to fill in the panel as the first content slides out of the panel. Yet another example of the transition effect may include an animation. For instance, an animated effect such as a swirl may form over the first content and as the first image swirls toward a center point of the swirling motion, the second content may fill in the panel from an out portion of the swirl. Other examples of transition effects are also possible and should not be limited to the examples disclosed herein.

As disclosed herein, each of the panels may be one or more layers and a layer engine may control the content displayed and the transition effect for each of the panels. For example, the layer engine may render and control media assets and other content on the display. The media may be in the form of a playlist. Also, each panel may have a separate playlist. In another example, a master playlist may contain all the content to be displayed and the layer engine may assign the content to different panels as disclosed herein.

As disclosed herein, a new layer may be created apart from a display's normal display windows. The new layer may be used as a consolidated view layer. The separate content panels, media assets, layers, visual elements, etc. may be combined and redrawn onto the view layer by the layer engine. The view layer can then be transformed or manipulated as a single piece of media by the layer engine. As disclosed herein, the layer engine may apply a graphics transform to the view layer in order to apply a custom animation or other transition effect to the view layer.

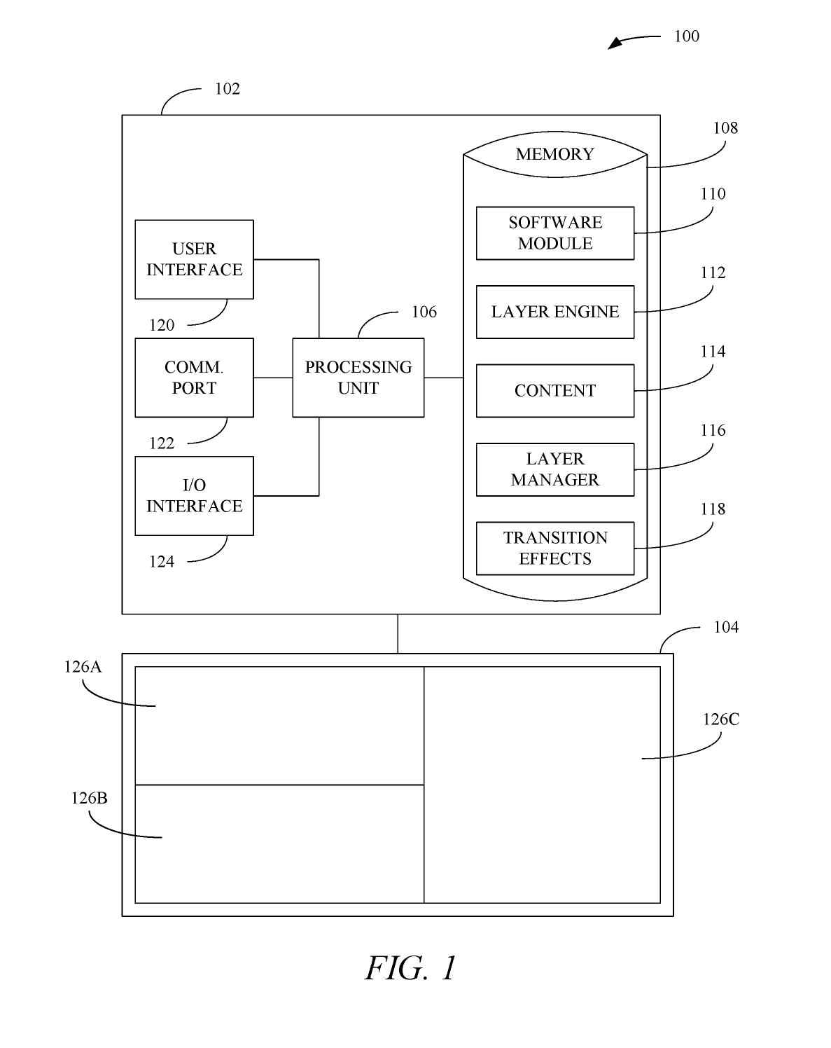

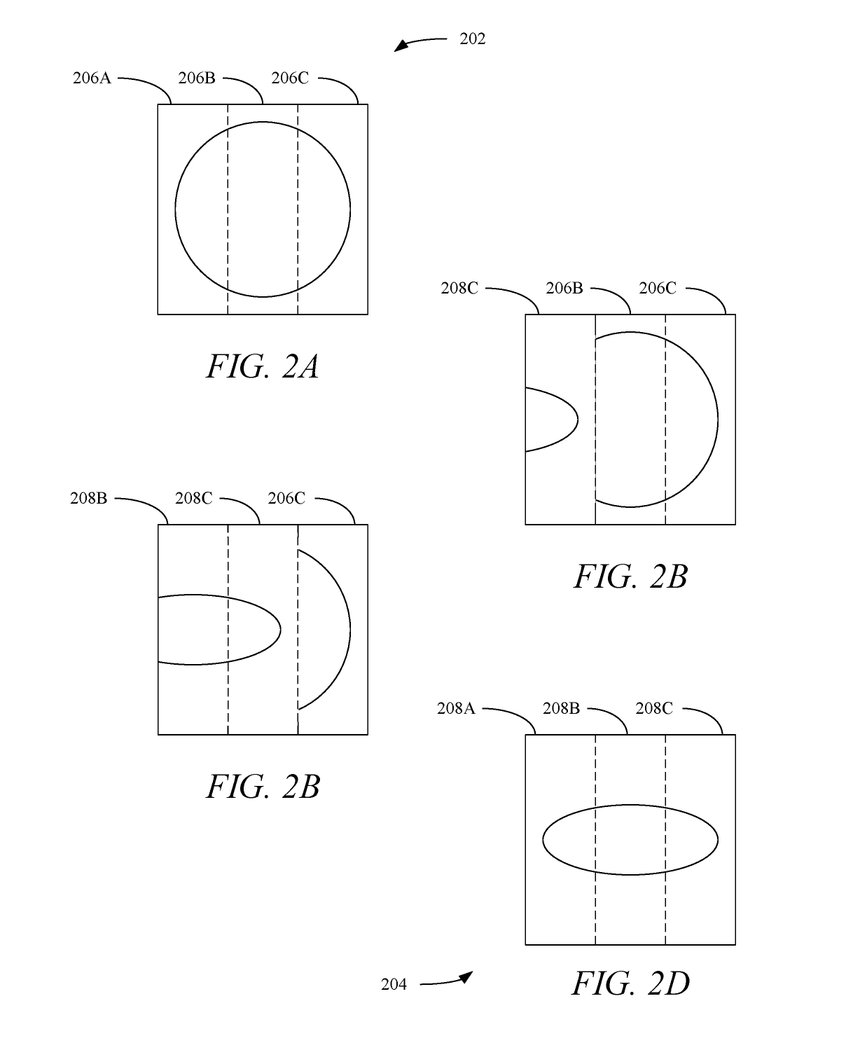

FIG. 1 shows an operating environment 100 for a layer engine for media transition effects consistent with this disclosure. The operating environment 100 may include a computing device 102 and a display 104. As shown in FIG. 1, the computing device may include a processing unit 106 and a memory 108. The memory 108 may include a software module 110, a layer engine 112, content 114, a layer manager 116, and transition effects 118. While executing on processing unit 106, the software module 110, the layer engine 112, the content 114, the layer manager 116, and the transition effects 118 may perform processes for transitioning from a first content to a second content, including, for example, one or more stages included in a method 200 described below with respect to FIG. 2.

The computing device also may include a user interface 120. The user interface 120 can include any number of devices that allow a user to interface with the computing device 102. Non-limiting examples of the user interface 120 include a keypad, a microphone, a speaker, etc.

The computing device 102 also may include a communications port 122. The communications port 122 may allow the computing device 102 to communicate with information systems and external computing devices. Non-limiting examples of the communications port 122 include, Ethernet cards (wireless or wired), Bluetooth® transmitters and receivers, near-field communications modules, etc.

The computing device 102 also may include an input/output (I/O) device 124. I/O device 124 may allow the computing device 102 to receive and output information. Non-limiting examples of I/O device 124 include, a camera (still or video), a printer, a scanner, etc.

The computing device 102 may be implemented using a personal computer, a network computer, a mainframe, or any other similar microcomputer-based workstation. The computing device 102 may be integrated with the display 104. For example, the computing device 102 may be contained within the same housing as the display 104. The computing device 102 also may be remote from the display 104. For instance, the computing device 102 can be a server or other computer located at a remote site and communicate with the display via the communications port 122. In addition, the computing device 102 may be a personal computer located in an office onsite with the display 104 and may communicate with the display 104 via a Wi-Fi or Bluetooth connection.

The display 104 may be any display including, but not limited to, a liquid crystal display (LCD), a light emitting diode (LED) display, a plasma display, etc. As disclosed herein, the display 104 may be divided into one or more panels 126A, 126B, and 126C (collectively panels 126). Each of the panels 126 may display content independently of the other panels 126. For example, the panel 126A may display a scrolling menu while panel 126B displays a static image and panel 126C displays a video. The content displayed within the panels 126 may change over time. For example, the video displayed in panel 126C and the static image displayed in panel 126B may change depending upon a location within the scrolling menu displayed in panel 126A.

As the content within the panels 126 changes, a transition effect may be used. For example, to keep from having a sudden change in content that may be unappealing to a viewer's eyes, a transition effect may be used to smooth the transition from a first content to a second content.

As disclosed herein the layer engine 112 can be used to control the content 114 and the transition effects 118 displayed on the display 104. For example, as disclosed herein, there may be a consistency with how all of the different types of media (i.e., content) are rendered. Thus, each media type may draw to a graphics context belonging to a parent control or panel. When the view layer is rendered by the layer engine 112, the view layer may be its own graphics context. The graphics context created by the layer engine 112 can then be passed to a top-level panel for each of the panels 126. An iterative call may be made to the render logic for the controls that apply to a given media (i.e., content). The result is that each control is drawing to the view layer instead of a parent context to form a snapshot of the content to be displayed in the panels 126. In the end, the render logic need not change for each type of media, but instead renders just the view layer.

Once the snapshot is rendered to the view layer, a visual transformation can be made to the layer itself as a whole instead of each individual control in a panel. In addition, other transformations may be made to the snapshot. For example, the snapshot may be animated or transformed independently of the media content. Also, overlays, such a text or filters may be applied to the snapshot via the layer engine 112.

As disclosed herein, each of the panels 126 may be its own layer and the layer engine 112 may apply transitions and other renderings as disclosed herein to individual layers or panels within a layer. For example, panel 126A and 126B may form a first layer and panel 126C may form a second layer. Snapshots of each layer may be formed independently of one another. This may allow for increased efficiency in that one layer may be static and thus repeated rendering may not be needed. For instance, the first layer with panels 126A and 126B may be static images that remain constant for a fixed period of time (e.g., an hour or a length of a slide presentation displayed in panel 126C). As a result, the layer engine 112 can create the snapshot of the first layer once and reuse the results repeatedly. The second layer may include multiple instances of content that will be transitioned over the fixed period of time. For example, the second layer may show a first video, followed by a first still image, followed by a second video, and a second still image. Thus, the layer engine 112 can create various snapshots as needed for the transition from images to the videos for the second layer without having to render the first layer each time the second layer is rendered.

The layer manager 118 may control the displaying of the first and second layers. For instance, the layer manager 118 may cause the first layer to de displayed independently of the second layer. Once each snapshot of the second layer is rendered, the layer manager 118 may cause the newly rendered second layer to be displayed on top of the first layer.

As disclosed herein the layer engine 112 may control the application of the transition effects 118 to the content 114. Each of the snapshots formed by the layer engine 112 may be a snapshot in time of the transition. For instance, a transition from a first still image to a second still image may occur over a preset time period (e.g., 2 seconds). The time period may be divided into multiple increments (e.g., 0.1 seconds). Each increment of time may result in a snapshot. Thus, the transition from the first still image to the second still image may result in 20 snapshots that are rendered by the layer engine 112 and displayed on the display 104.

FIGS. 2A-2D shows an example transition sequence consistent with this disclosure. FIG. 2A shows a first image 202 and FIG. 2D shows a second image 204. The transition sequence may be a slide right transition. In other words, the first image 202 may appear to slide off of the panel to the right and as it slides to the right, the second image 204 may appear on the panel from the left. For simplicity, the time interval X has been divided into three equal segments. Thus, the first image 202 has been divided into segment 206A, 206B, and 206C (collectively segments 206) and the second image 204 has been divided into segment 208A, 208B, and 208C (collectively segments 208). As shown in FIG. 2B, after the first time interval, the segment 206A is replaced by segment 208C. After the second time interval, segment 206A and segment 206B have been replaced by segment 208B and 208C, respectively (FIG. 2C). At the end of the time interval, the first image 202 has been replaced by the second image 204 as shown in FIG. 2D. While FIGS. 2A-2D use a still image as example content, the content can be video, scrolling text, text.

Each of FIGS. 2A-2D may represent a snapshot. Each of the snapshots may be rendered by the layer engine 112. Once rendered into a layer by the layer engine 112, the layer manager 116 may organize the layers such that they are displayed correctly to form a smooth transition between the first image 202 and the second image 204. In FIGS. 2A-2D a small number of increments was used for simplicity. However, the number of increments may be such that the transition appears smooth when viewed by a viewer. Stated another way, the example increments of 0.1 seconds and 3 are merely illustrative of increments and the actual increments may be shorter or longer length of time.

In another example, FIGS. 2A-2D collectively may represent a snapshot. As such, the layer engine 112 may manipulate the various portions of the transition effect in a collective manner as opposed to manipulating each frame of the transition effect individually. By considering the frames of the transition effect collectively, the layer engine 112 may exercise greater control over the transition effect. For example, by considering the frames of the transition effect collectively, the layer engine 112 may control the type of transition effect (e.g., swipe, fade, etc.) as well as the timing or duration of the transition effect. For instance, the layer engine 112 may control the overall duration of the transition effect as well as the timing between different frames of the transition effect.

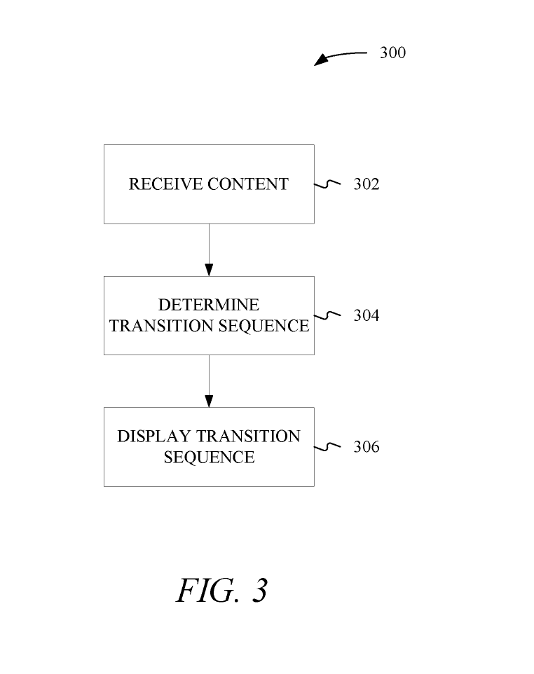

FIG. 3 shows an example method 300 for applying a transition effect consistent with this disclosure. The method 300 may begin at stage 302, where a first content and a second content may be received. As disclosed herein the first and second content may be a video, an image, an animation, etc. The first and second content can be for displaying on a panel of a display. The panel may be one of multiple panels. In addition to the first and second content, other content may be received for displaying on other panels of the display as disclosed herein.

From stage 302, the method 300 may proceed to state 304, where a transition sequence may be determined. The transition sequence may be selected by a user or selected by the computing device 102. For example, the user may provide an input that allows the computing device 102 to determine which of a plurality of transition sequences to apply. In another embodiment, the computing device 102 may select a transition sequence at random from the transition effects 118. As detailed above, the transition sequence can allow for the first content to transition to the second content in a predetermined fashion so as to appear smooth to a viewer as opposed to a sudden change in content.

From stage 304, the method 300 may proceed to stage 306, where the transition sequence may be displayed. As disclosed herein, displaying the transition sequence may include forming a snapshot of each frame of the transition sequence as layers to be displayed by the layer engine 112. Once the snapshots are formed, the layer manager 116 may organize the layers to be displayed on the display 104. In addition, displaying the transition sequence may include drawing a single graphics context and the layer engine manipulating the single graphics context.

As disclosed herein, displaying the transition sequence may include displaying a transition sequence for each panel of a plurality of panels. In addition, the transition sequence may include dividing the display into a plurality of panels or resizing existing panels. For example, during a transition from content displayed in each of the panels 126, the panels 126 may be resized. As a result, the layer engine 112 may create snapshots that show the panels 126 morphing from a first size to a second size. As part of the resizing process, the content may be resized as well. For example, an image or video may be shrunk or enlarged to fit within a resized panel. In addition, an image or a video may be cropped to fit within the resized panel. Furthermore, the panel may be resized to fit the content. For example, an image may be X by Y pixels in size and the panel in which the image is to be displayed may be W by H pixels, where W is less/greater than X and/or H is less/greater than Y. As a result, panel may be resized to Y by Y pixels so the content can be displayed without being resized. In addition to being resized, the panels 126 also can be reshaped. For example, one of the panels may be a rectangle when displaying a first content and may be reshaped to a circle when displaying the second content.

### EXAMPLES

Example 1 is a method for transitioning from a first content to a second content on a display, the method comprising: receiving, at a computing device comprising a processor, the first content and the second content; determining, by the computing device, a transition sequence for transitioning from the first content to the second content; and displaying, by the computing device, the transition sequence on a first panel of the display, the display divided into a plurality of panels.

In Example 2, the subject matter of Example 1 optionally includes dividing the display into the plurality of panels.

In Example 3, the subject matter of any one or more of Examples 1-2 optionally include wherein each of the plurality of panels displays different content.

In Example 4, the subject matter of any one or more of Examples 1-3 optionally include receiving a third content and a fourth content to be displayed on a second panel of the display; determining, a second transition sequence for transitioning from the third content to the second content; and displaying the second transition sequence on the second panel of the display.

In Example 5, the subject matter of Example 4 optionally includes wherein the first transition sequence is displayed independently of the second transition sequence.

In Example 6, the subject matter of any one or more of Examples 1-5 optionally include wherein the first content is a static image and the second content is a video.

In Example 7, the subject matter of Example 6 optionally includes wherein the video plays during the transaction sequence.

In Example 8, the subject matter of any one or more of Examples 1-7 optionally include wherein the transition sequence includes resizing the first panel of the display.

In Example 9, the subject matter of any one or more of Examples 1-8 optionally include resizing at least the first panel from a first size to a second size; resizing at least the second content to the second size, wherein displaying the transition sequence includes displaying the transition sequence during a refresh operation in which the first panel transitions from the first size to the second size.

Example 10 is a system for transitioning content, the system comprising: a display; a processor; and a memory storing instructions that, when executed by the processor, cause the processor to: divide the display into a first panel and a second panel, receive a first content and a second content to be displayed in the first panel, receive a third content and a fourth content to be displayed in the second panel, form a first snapshot of the first panel and the second panel displaying the first content and the third content, form a second snapshot of the first panel and the second panel displaying the second content and the third content, determine a first transition sequence for transitioning from the first snapshot to the second snapshot, and display the first transition sequence on the display.

In Example 11, the subject matter of Example 10 optionally includes wherein displaying the first transition sequence includes instructions that, when executed by the processor, further cause the processor to display the first transition sequence independently of displaying a second transition sequence.

In Example 12, the subject matter of any one or more of Examples 10-11 optionally include wherein the first content is a first static image, the second content is a first video, the third content is a second video, and the fourth content is a second static image.

In Example 13, the subject matter of Example 12 optionally includes wherein the instructions, when executed by the processor, further cause the processor to play the first video during the first transition sequence and the second video plays during the second transition.

In Example 14, the subject matter of any one or more of Examples 10-13 optionally include wherein the instructions, when executed by the processor, further cause the processor to display the first transition at a different time than a second transition.

In Example 15, the subject matter of any one or more of Examples 10-14 optionally include wherein the first panel and the second panel have a different size or a different shape.

In Example 16, the subject matter of any one or more of Examples 10-15 optionally include wherein the instructions that, when executed by the processor, further cause the processor to: resize the first panel from a first size to a second size; resize the second content to the second size, wherein displaying the first transition sequence includes displaying the first transition sequence during a refresh operation in which the first panel transitions from the first size to the second size; resize the second panel from a third size to a fourth size; and resize the fourth content to the fourth size, wherein displaying the first transition sequence includes displaying the first transition sequence during the refresh operation in which the second panel transitions from the third size to the fourth size.

Example 17 is a non-transitory computer readable medium storing instructions that, when executed by a processor, cause the processor to: dividing the display into a first panel and a second panel, receiving a first content and a second content to be displayed in the first panel, receiving a third content and a fourth content to be displayed in the second panel, forming a first snapshot of the first panel and the second panel displaying the first content and the third content, forming a second snapshot of the first panel and the second panel displaying the second content and the third content, determining a first transition sequence for transitioning from the first snapshot to the second snapshot, and display the first transition sequence on the display.

In Example 18, the subject matter of any one or more of Examples 15-17 optionally include wherein the instructions, when executed by the processor, further cause the processor to: resize the first panel from a first size to a second size; resize the second content to the second size, wherein displaying the first transition sequence includes displaying the first transition sequence during a refresh operation in which the first panel transitions from the first size to the second size; resize the second panel from a third size to a fourth size; and resize the fourth content to the fourth size, wherein displaying the first transition sequence includes displaying the first transition sequence during the refresh operation in which the second panel transitions from the third size to the fourth size.

In Example 19, the subject matter of any one or more of Examples 17-18 optionally include wherein the instructions, when executed by the processor, further cause the processor to display the first transition sequence independently of displaying a second transition sequence.

In Example 20, the subject matter of any one or more of Examples 17-19 optionally include wherein the instructions, when executed by the processor, further cause the processor to play the first video during the first transition sequence and the second video plays during the second transition.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method for transitioning from a first content to a second content on a display, the method comprising:
receiving, at a computing device comprising a processor, the first content and the second content;
determining, by the computing device, a transition sequence for transitioning from the first content to the second content; and
displaying, by the computing device, the transition sequence on a first panel of the display, the display divided into a plurality of panels.

2. The method of claim 1, further comprising dividing the display into the plurality of panels.

3. The method of claim 1, wherein each of the plurality of panels displays different content.

4. The method of claim 1, further comprising:
receiving a third content and a fourth content to be displayed on a second panel of the display;
determining, a second transition sequence for transitioning from the third content to the second content; and
displaying the second transition sequence on the second panel of the display.

5. The method of claim 4, wherein the first transition sequence is displayed independently of the second transition sequence.

6. The method of claim 1, wherein the first content is a static image and the second content is a video.

7. The method of claim 6, wherein the video plays during the transaction sequence.

8. The method of claim 1, wherein the transition sequence includes resizing the first panel of the display.

9. The method of claim 1, further comprising:
resizing at least the first panel from a first size to a second size;
resizing at least the second content to the second size, wherein displaying the transition sequence includes displaying the transition sequence during a refresh operation in which the first panel transitions from the first size to the second size.

10. A system for transitioning content, the system comprising:
a display;
a processor; and
a memory storing instructions that, when executed by the processor, cause the processor to:
divide the display into a first panel and a second panel,
receive a first content and a second content to be displayed in the first panel,
receive a third content and a fourth content to be displayed in the second panel,
form a first snapshot of the first panel and the second panel displaying the first content and the third content,
form a second snapshot of the first panel and the second panel displaying the second content and the third content,
determine a first transition sequence for transitioning from the first snapshot to the second snapshot, and
display the first transition sequence on the display.

11. The system of claim 10, wherein displaying the first transition sequence includes instructions that, when executed by the processor, further cause the processor to display the first transition sequence independently of displaying a second transition sequence.

12. The system of claim 10, wherein the first content is a first static image, the second content is a first video, the third content is a second video, and the fourth content is a second static image.

13. The system of claim 12, wherein the instructions, when executed by the processor, further cause the processor to play the first video during the first transition sequence and the second video plays during the second transition.

14. The system of claim 10, wherein the instructions, when executed by the processor, further cause the processor to display the first transition at a different time than a second transition.

15. The system of claim 10, wherein the first panel and the second panel have a different size or a different shape.

16. The system of claim 10, wherein the instructions that, when executed by the processor, further cause the processor to:
resize the first panel from a first size to a second size;
resize the second content to the second size, wherein displaying the first transition sequence includes displaying the first transition sequence during a refresh operation in which the first panel transitions from the first size to the second size;
resize the second panel from a third size to a fourth size; and
resize the fourth content to the fourth size, wherein displaying the first transition sequence includes displaying the first transition sequence during the refresh operation in which the second panel transitions from the third size to the fourth size.

17. A non-transitory computer readable medium storing instructions that, when executed by a processor, cause the processor to:
divide the display into a first panel and a second panel,
receive a first content and a second content to be displayed in the first panel,
receive a third content and a fourth content to be displayed in the second panel,
form a first snapshot of the first panel and the second panel displaying the first content and the third content,
form a second snapshot of the first panel and the second panel displaying the second content and the third content,
determine a first transition sequence for transitioning from the first snapshot to the second snapshot, and
display the first transition sequence on the display.

18. The non-transitory computer readable medium of claim 15, wherein the instructions, when executed by the processor, further cause the processor to:
resize the first panel from a first size to a second size;
resize the second content to the second size, wherein displaying the first transition sequence includes displaying the first transition sequence during a refresh operation in which the first panel transitions from the first size to the second size;
resize the second panel from a third size to a fourth size; and
resize the fourth content to the fourth size, wherein displaying the first transition sequence includes displaying the first transition sequence during the refresh operation in which the second panel transitions from the third size to the fourth size.

19. The non-transitory computer readable medium of claim 17, wherein the instructions, when executed by the processor, further cause the processor to display the first transition sequence independently of displaying a second transition sequence.

20. The non-transitory computer readable medium of claim 17, wherein the instructions, when executed by the processor, further cause the processor to play the first video during the first transition sequence and the second video plays during the second transition.
